(19) United States
(12) Patent Application Publication
(10) Pub. No.: US 2025/0103349 A1
(43) Pub. Date: Mar. 27, 2025

(54) INFORMATION PROCESSING APPARATUS

(71) Applicant: Mitsubishi Electric Corporation, Tokyo (JP)

(72) Inventors: Ryota KITAGAWA, Tokyo (JP); Katsuhisa OGASAWARA, Tokyo (JP); Daisuke KAWAKAMI, Tokyo (JP); Haruhiko TAKEYAMA, Tokyo (JP)

(73) Assignee: Mitsubishi Electric Corporation, Tokyo (JP)

(21) Appl. No.: 18/290,916

(22) PCT Filed: Jul. 28, 2021
(86) PCT No.: PCT/JP2021/027911

§ 371 Date: Jan. 22, 2024

(51) Int. Cl. G06F 9/445

(52) U.S. Cl. CPC G06F 9/445

(57) ABSTRACT

The present disclosure has an object to provide an information processing apparatus that can reduce jitter due to an operating system, depending on a state of execution of an application, without provision of dedicated hardware. An information processing apparatus according to the present disclosure includes a computation apparatus including a plurality of processor cores, and an operating system. The operating system includes an OS jitter statistical information acquisition unit configured to acquire OS jitter statistical information of the operating system, an OS jitter statistical information table defining an OS jitter level associated with the OS jitter statistical information, an input value acquisition unit configured to acquire an input value of an application, a computational load table defining a computational load level associated with the input value, and a bare metal necessity determination unit configured to determine whether or not a processing block needs to be executed in a bare metal environment in which the operating system is not executed, based on the OS jitter level and the computational load level.

### TECHNICAL FIELD

The present disclosure relates to an information processing apparatus that provides an execution environment with reduced jitter due to an operating system, based on a state of execution of an application in a real-time system.

### BACKGROUND ART

Conventionally, a controller in a real-time system has adopted a dedicated real time operating system (RTOS) in order to secure real-time property of an application (real-time application). In recent years, there have been schemes for integration and distributed coordination, in which a control system application for which high real-time property is required and an information system application are simultaneously operated to allow mutual cooperation on a single high-performance controller. However, the RTOS has only functions specialized for securing real-time property, and does not provide execution environments, such as a library and a runtime, that are necessary for the information system application utilizing internet of things (IoT) or artificial intelligence (AI) technology. Thus, in the real-time system, a controller adopting a general-purpose operating system (OS), such as Linux (trademark; hereinafter the same), has been more widely used.

The general-purpose OS performs various types of processes, and thus has greater jitter (hereinafter referred to as “OS jitter”) than that of the RTOS, due to processes of the general-purpose OS itself, such as a thread process in the kernel and an I/O process for performing connection with another device, as well as the control system application and the information system application. Accordingly, it is difficult to secure real-time property. In addition, owing to integration and distributed coordination of the controller described above, as the scale of the system is larger, increase of a processing time of one application due to OS jitter mom easily affects performance of the overall system. For example, in visual feedback in a factory automation (FA) field, an image processing application itself may not be a hard real-time application; however, when a subsequent control system application that performs positioning and the like is a hard real-time application, malfunction of the control system application due to occurrence of OS jitter with a long processing time during execution of the image processing application must be avoided. In this manner, in the real-time system, it is further required to address even the OS jitter with a long processing time as a new problem in future, even if occurrence frequency of the OS jitter is low.

Integration and distributed coordination of the controller, on the other hand, also have an aspect of improvement of functions such as software update and addition of an application. In operation of the system, a state of execution of an application changes over time, and accordingly, a state of occurrence of OS jitter changes as well.

Depending on a state of execution of an application, a case is considered in which OS jitter must be reduced as the OS jitter critically affects performance of the overall system, or conversely OS jitter need not be addressed. Thus, an execution environment for dynamically reducing OS jitter depending on a state of execution of an application is required.

In a conventional information processing apparatus that executes a real-time application, variations of performance and interference with another application in the general-purpose OS are reduced by offloading a part of processing to dedicated hardware such as a field programmable gate array (FPGA) at the time of execution processing of a part of an application (for example, see Patent Document 1).

### PRIOR ART DOCUMENTS

### Patent Document

Patent Document 1: Japanese Patent Application Laid-Open No. 2020-166427

### SUMMARY

### Problem to be Solved by the Invention

The information processing apparatus that executes a real-time application as in Patent Document 1 presupposes that dedicated hardware is provided in the apparatus in advance, and thus there is a problem in that it cannot be applied to an information processing apparatus not equipped with dedicated hardware or in that costs of productization increases. Further, it does not include a mechanism of dynamically offloading a part of processing of an application to dedicated hardware. Thus, there is a problem in that jitter of the operating system cannot be reduced depending on a change of an actual state of the application.

The present disclosure is made in order to solve the problems as described above, and has an object to provide an information processing apparatus that can reduce jitter due to an operating system, depending on a state of execution of an application, without provision of dedicated hardware.

### Means to Solve the Problem

In order to solve the problems described above, an information processing apparatus according to the present disclosure includes a computation apparatus including a plurality of processor cores, and an operating system to be executed in the computation apparatus. The operating system includes an OS jitter statistical information acquisition unit configured to acquire OS jitter statistical information being statistical information of OS jitter occurring in processing of the operating system, an OS jitter statistical information table defining an OS jitter level being a level of OS jitter, the OS jitter level being associated with the OS jitter statistical information, an input value acquisition unit configured to acquire an input value of the application, a computational load table defining a computational load level being a level of a computational load of a processing block constituting the application, the computational load level being associated with the input value, and a bare metal necessity determination unit configured to determine whether or not the processing block needs to be executed in a bare metal environment in which the operating system is not executed, based on the OS jitter level and the computational load level.

### Effects of the Invention

According to the present disclosure, jitter due to an operating system can be reduced, depending on a state of execution of an application, without provision of dedicated hardware.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a block diagram illustrating an example of a configuration of an information processing apparatus according to a first embodiment.

FIG. 2 is a flowchart illustrating an example of operation of an OS jitter statistical information acquisition unit according to the first embodiment.

FIG. 3 is a diagram illustrating an example of an OS jitter statistical information table according to the first embodiment.

FIG. 4 is a diagram illustrating an example of assumed processing time variation when OS jitter occurs according to the first embodiment.

FIG. 5 is a flowchart illustrating an example of operation of an input value acquisition unit according to the first embodiment.

FIG. 6 is a diagram illustrating an example of a computational load table according to the first embodiment.

FIG. 7 is a diagram illustrating an example of a bare metal necessity determination table according to the first embodiment.

FIG. 8 is a flowchart illustrating an example of operation of a bare metal necessity determination unit according to the first embodiment.

FIG. 9 is a flowchart illustrating an example of operation of a bare metal building unit according to the first embodiment.

FIG. 10 is a diagram illustrating an example of a bare metal building latency table according to the first embodiment.

FIG. 11 is a flowchart illustrating an example of operation of a bare metal loader unit according to the first embodiment.

FIG. 12 is a flowchart illustrating an example of operation of a bare metal cooperation unit according to the first embodiment.

FIG. 13 is a flowchart illustrating an example of operation of a computation application generation unit according to the first embodiment.

FIG. 14 is a diagram illustrating an example of a function table according to the first embodiment.

FIG. 15 is a block diagram illustrating an example of a configuration of an information processing apparatus according to a second embodiment.

FIG. 16 is a diagram illustrating an example of a cache statistical information table according to the second embodiment.

FIG. 17 is a diagram illustrating an example of a bare metal necessity determination table according to the second embodiment.

FIG. 18 is a flowchart illustrating an example of operation of a bare metal necessity determination unit according to the second embodiment.

FIG. 19 is a block diagram illustrating an example of a configuration of an information processing apparatus according to a third embodiment.

FIG. 20 is a flowchart illustrating an example of operation of a computational load learning unit according to the third embodiment.

FIG. 21 is a flowchart illustrating an example of operation of a computational load estimation unit according to the third embodiment.

### DESCRIPTION OF EMBODIMENTS

### First Embodiment

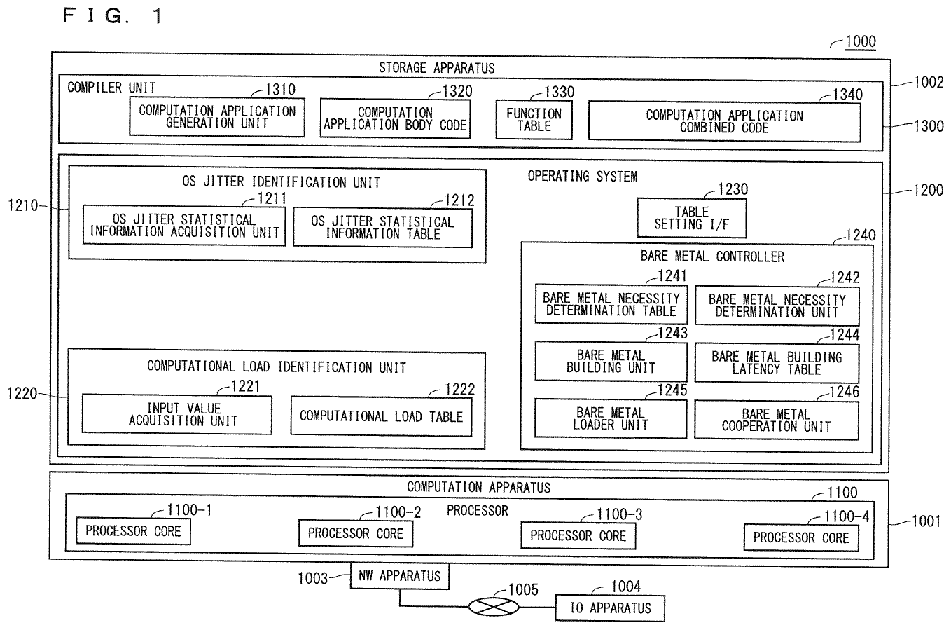

FIG. 1 is a block diagram illustrating an example of a configuration of an information processing apparatus 1000 according to a first embodiment.

The information processing apparatus 1000 includes a computation apparatus 1001 and a storage apparatus 1002. The information processing apparatus 1000 is connected to a network 1005 via a network (NW) apparatus 1003, and acquires data from an Input Output (IO) apparatus 1004. The NW apparatus 1003 is serial communication, Ethernet (trademark), or the like, and forms connection between one or more IO apparatuses 1004 and the computation apparatus 1001. The IO apparatus 1004 is various types of sensors, for example.

The computation apparatus 1001 executes various types of programs. The computation apparatus 1001 includes one or more processors 1100. The processor 1100 is a central processing unit (CPU), for example. The processor 1100 includes two or more processor cores 1100-1 to 1100-4. Note that, although FIG. 1 illustrates four processor cores 1100-1 to 1100-4, this is not restrictive.

The storage apparatus 1002 stores programs and data necessary for execution of the programs. The storage apparatus 1002 is cache memory, random access memory (RAM), read only memory (ROM), a hard disk drive (HDD), or the like, for example.

Next, a functional configuration of the storage apparatus 1002 will be described. The storage apparatus 1002 includes an operating system 1200 and a compiler unit 1300. The operating system 1200 is a general-purpose OS such as Linux, and includes functions of the general-purpose OS. In the compiler unit 1300, executable binary data that is executable in both of an environment in which the OS is executed (hereinafter referred to as an “operating system environment (OS environment)”) and an environment in which the OS is not executed (hereinafter referred to as a “bare metal environment”) is generated by a computation application generation unit 1310. The executable binary data that is executable in the OS environment is hereinafter referred to as “executable binary data for the OS environment (executable binary data for the operating system environment)”, and the executable binary data that is executable in the bare metal environment as “executable binary data for the bare metal environment”. The executable binary data for the OS environment and the executable binary data for the bare metal environment are generated based on a computation application combined code 1340 that is generated from a computation application body code 1320 and a function table 1330.

The operating system 1200 includes an OS jitter identification unit 1210, a computational load identification unit 1220, a table setting I/F 1230, and a bare metal controller 1240.

The OS jitter identification unit 1210 includes an OS jitter statistical information acquisition unit 1211 and an OS jitter statistical information table 1212. The OS jitter statistical information acquisition unit 1211 acquires statistical information related to various types of processing of the operating system. Regarding the OS jitter statistical information table 1212, a user defines in advance, for each of types of OS jitter and items to be monitored, ranges of numerical values thereof and their corresponding levels (OS jitter levels). The current OS jitter level is identified based on the OS jitter statistical information acquisition unit 1211 and the OS jitter statistical information table 1212.

The computational load identification unit 1220 includes an input value acquisition unit 1221 and a computational load table 1222. The input value acquisition unit 1221 acquires input values from the IO apparatus 1004 via the NW apparatus 1003. Regarding the computational load table 1222, the user defines in advance, ranges of numerical values of processing times and their corresponding levels (computational load levels), in association with the input values. The current computational load level is identified based on the input value acquisition unit 1221 and the computational load table 1222.

The bare metal controller 1240 includes a bare metal necessity determination table 1241, a bare metal necessity determination unit 1242, a bare metal building unit 1243, a bare metal building latency table 1244, a bare metal loader unit 1245, and a bare metal cooperation unit 1246. The user sets conditions necessary for executing each processing block in the bare metal environment via the table setting I/F 1230, and the setting is reflected in the bare metal necessity determination table 1241. Note that granularity of the processing block may be a unit of an application, or may be a unit (for example, a function) of a constituent element of an application.

The bare metal necessity determination unit 1242 makes an inquiry about the current OS jitter level identified by the OS jitter identification unit 1210 and the current computational load level identified by the computational load identification unit 1220 to the bare metal necessity determination table 1241, and determines whether or not a corresponding processing block (a processing block as an execution target) is to be executed in the bare metal environment.

The bare metal building unit 1243 builds the bare metal environment for any one or more processor cores out of the processor cores 1100-1 to 1100-4, based on determination results of the corresponding processing block.

The bare metal building latency table 1244 stores overhead times of operations required for building of the bare metal environment, and is used for performing control so that there is no influence of latency when the bare metal environment is built.

The bare metal loader unit 1245 deploys the executable binary data for the bare metal environment of the corresponding processing block in a virtual address set in advance. The bare metal cooperation unit 1246 performs execution control of the executable binary data for the OS environment, based on an execution status of the executable binary data for the bare metal environment.

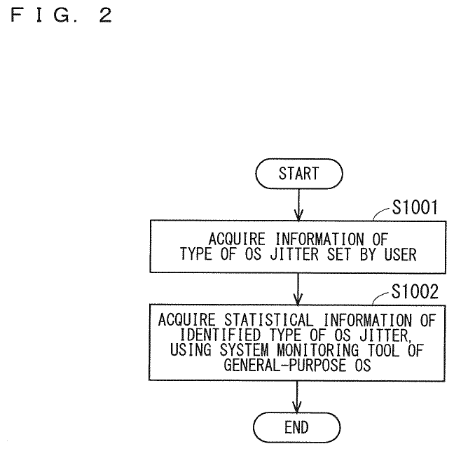

FIG. 2 is a flowchart illustrating an example of operation of the OS jitter statistical information acquisition unit 1211.

In Step S1001, the OS jitter statistical information acquisition unit 1211 acquires information of a type of OS jitter set by the user from the OS jitter statistical information table 1212 to be described later.

In Step S1002, the OS jitter statistical information acquisition unit 1211 acquires statistical information of the acquired type of OS jitter, using a system monitoring tool provided by the general-purpose OS. For example, when statistical information related to a kernel process is acquired with Linux, a user time ratio or a system time ratio can be acquired by using a top command.

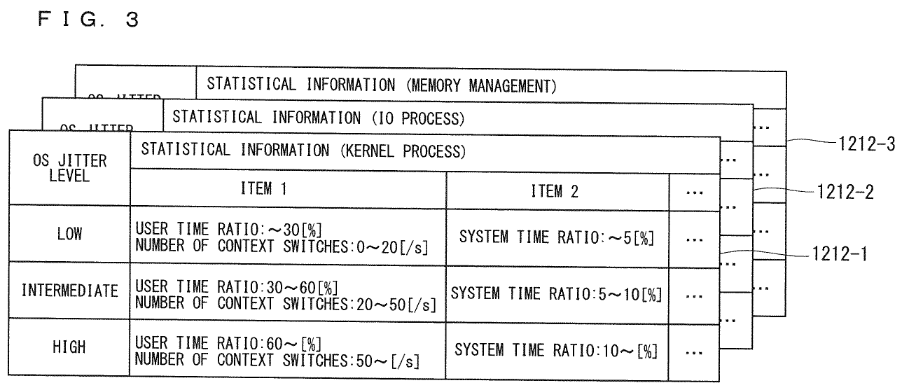

FIG. 3 is diagram illustrating an example of the OS jitter statistical information table 1212.

The OS jitter statistical information table 1212 is a table that stores items to be monitored and OS jitter levels corresponding to the ranges of numerical values of the respective items regarding the type of OS jitter selected by the user. The OS jitter has, for example, various types such as a kernel process, an IO process, and memory management in the operating system. At a preparation stage, the user sets types of OS jitter, monitoring items for each type, and ranges of numerical values and OS jitter levels for each monitoring item.

In the example of FIG. 3, as the types of OS jitter, three types are set, i.e., a kernel process 1212-1, an IO process 1212-2, and memory management 1212-3. Further, in the kernel process 1212-1, as the monitoring items, three items are set, i.e., a user time ratio, the number of context switches, and a system time ratio. Note that the types of OS jitter and the monitoring items are not limited to these. There may be either a single or a plurality of monitoring items for one type of OS jitter. When there a plurality of monitoring items, items as AND conditions are set in the same column, and items as OR conditions are set in columns different from each other. In the example of FIG. 3, regarding the kernel process 1212-1, the user time ratio and the number of context switches are both AND conditions, and are thus set in the column of “item 1”. The system time ratio is an OR condition among the user time ratio and the number of context switches, and is thus set in the column of “item 2”. Further, the OS jitter levels have 3-level setting of “low”, “intermediate”, and “high”. and the ranges of numerical values of the monitoring items are set at each level. Note that the OS jitter levels and the ranges of numerical values are not limited to these.

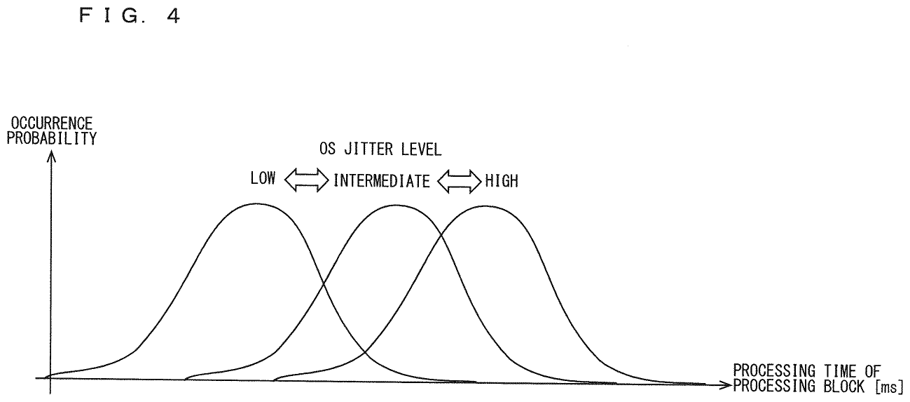

FIG. 4 is a diagram illustrating an example of assumed processing time variation when OS jitter occurs.

An establishment distribution of occurrence of the OS jitter such as the kernel process, the IO process, and the memory management of the operating system described above varies from moment to moment depending on a state of execution of an application. For example, when the number of applications to be executed increases, or when a processing load of each application being executed increases, threads in the kernel are less liable to be scheduled, and thus there is a case in which the processing time in each execution increases. In addition, a case is also assumed in which physical memory is exhausted and page-out or swapping frequently occurs owing to a memory management function.

The example of FIG. 4 schematically shows how the processing time of a processing block varies when the OS jitter level varies in a manner of “low”, “intermediate”, and “high”, and this implies that there is a case in which the OS jitter must be addressed severely depending on a state of execution of an application so that performance of the overall system is not affected. For example, in one application, when the OS jitter level is “low”, there is an extremely low probability of occurrence of OS jitter with such a long processing time that may cause a significant error in the overall system, and thus this need not be addressed. In contrast, when the OS jitter level is “high”, the probability is as high as 50% or more, and thus a case is assumed in which this must be addressed.

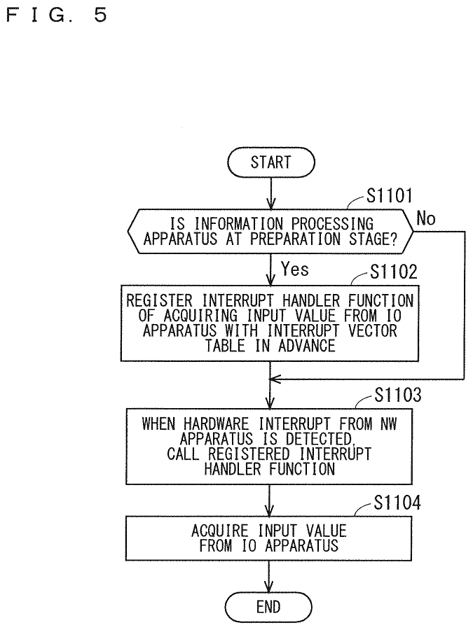

FIG. 5 is a flowchart illustrating an example of operation of the input value acquisition unit 1221.

Details of processing differ depending on whether the information processing apparatus 1000 is at a preparation stage or an operation stage.

In Step S1101, the input value acquisition unit 1221 determines whether or not the information processing apparatus 1000 is at the preparation stage.

In Step S1102, the input value acquisition unit 1221 registers an interrupt handler function of acquiring input values from the IO apparatus 1004 with an interrupt vector table in advance. The interrupt handler function is defined by the user, because the input values to be acquired differ depending on a target computation application.

In Step S1103, the stage transitions to the operation stage, and when the input value acquisition unit 1221 detects a hardware interrupt from the NW apparatus 1003, the input value acquisition unit 1221 calls the registered interrupt handler function.

In Step S1104, the input value acquisition unit 1221 acquires the input values from the IO apparatus 1004.

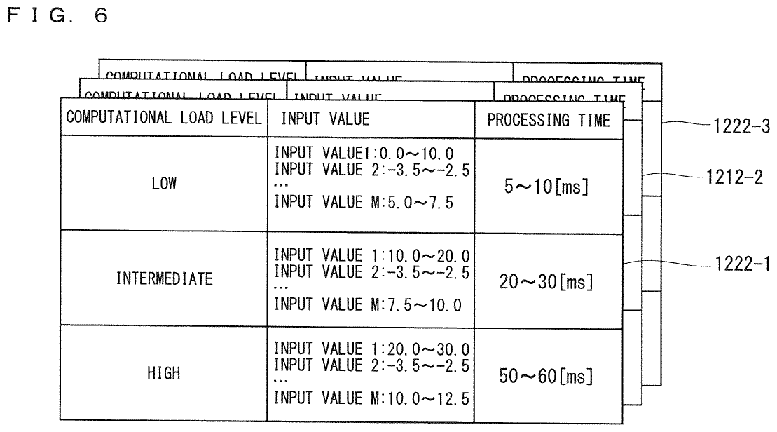

FIG. 6 is a diagram illustrating an example of the computational load table 1222.

At the preparation stage, the user sets the processing times of each processing block and their processing load levels, in association with the input values. Regarding measurement of the processing times, for example, at the preparation stage, only a target application is executed in the bare metal environment, and the processing time for each processing block is measured.

In the example of FIG. 6, each processing block has a different table, in a manner in which a processing block A has a table 1222-1, a processing block B has a table 1222-2, and a processing block C has a table 1222-3. The computational load levels are defined by the user at the preparation stage by determining the ranges of numerical values for the processing times. Although FIG. 6 has three levels of “low”, “intermediate”, and “high”, this is not restrictive.

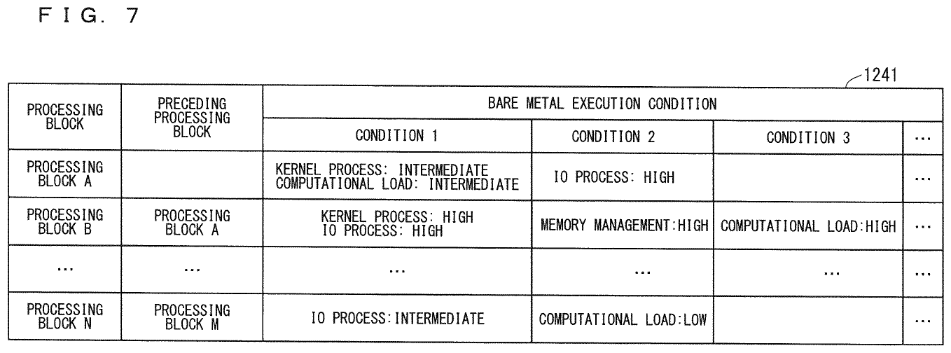

FIG. 7 is a diagram illustrating an example of the bare metal necessity determination table 1241.

At the preparation stage, the user sets bare metal execution conditions of a preceding processing block (one processing block executed before the corresponding processing block) and each processing block via the table determination I/F 1230. The bare metal execution condition refers to a condition that execution of the corresponding processing block in the bare metal environment is needed. As the conditions that execution in the bare metal environment is needed, the types of OS jitter and their OS jitter levels of the OS jitter statistical information table 1212 or the computational load levels of the computational load table 1222 set by the user at the preparation stage are set in bare metal execution condition columns. In this case, the types of OS jitter or the computational load as AND conditions are set in the same column, and the types of OS jitter or the computational load as OR conditions are set in columns different from each other.

In the example of FIG. 7, regarding the processing block A, the kernel process and the computational load are both AND conditions, and are thus set in the column of “condition 1”, and the IO process is an OR condition among the kernel process and the computational load, and is thus set in the column of “condition 2”. Note that not all the types of OS jitter set in the OS jitter statistical information table 1212 and the computational load set in the computational load table 1222 need to be set, and only those necessary for determination that execution of the corresponding processing block in the bare metal environment is needed may be set.

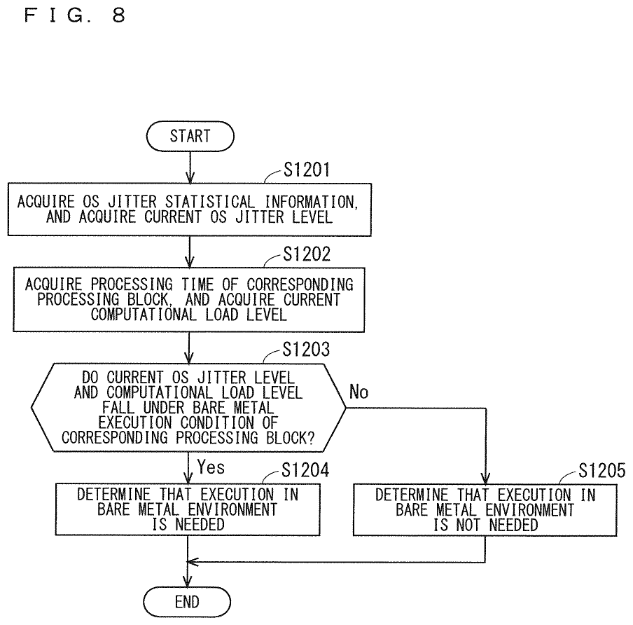

FIG. 8 is a flowchart illustrating an example of operation of the bare metal necessity determination unit 1242. Note that it is assumed that processing of bare metal necessity determination performed by the bare metal necessity determination unit 1242 is performed when the preceding processing block of the corresponding processing block is executed.

In Step S1201, the bare metal necessity determination unit 1242 acquires the current OS jitter statistical information from the OS jitter statistical information acquisition unit 1211, makes an inquiry to the OS jitter statistical information table 1212, and acquires a corresponding OS jitter level.

In Step S1202, the bare metal necessity determination unit 1242 makes an inquiry about the processing time of the corresponding processing block corresponding to an input value acquired by the input value acquisition unit 1221 to the computational load table 1222, and acquires the computational load level of the corresponding processing block.

In Step S1203, the bare metal necessity determination unit 1242 makes an inquiry about the current OS jitter level and computational load level to the bare metal necessity determination table 1241, and checks whether or not the current OS jitter level and computational load level fall under the bare metal execution condition of the corresponding processing block. When they fall under the bare metal execution condition, the operation proceeds to Step S1204. In contrast, when they do not fall under the bare metal execution condition, the operation proceeds to Step S1205.

In Step S1204, the bare metal necessity determination unit 1242 determines that execution of the corresponding processing block in the bare metal environment is needed.

In Step S1205, the bare metal necessity determination unit 1242 determines that execution in the bare metal environment is not needed.

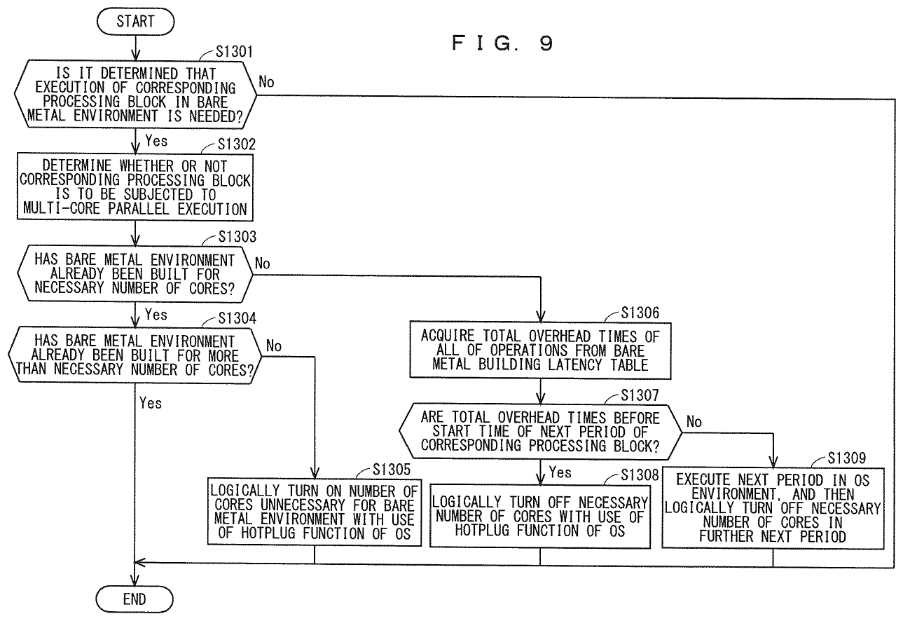

FIG. 9 is a flowchart illustrating an example of operation of the bare metal building unit 1243.

In Step S1301, the bare metal building unit 1243 checks whether or not it is determined that execution of the corresponding processing block in the bare metal environment is needed. When execution in the bare metal environment is needed, the operation proceeds to Step S1302. In contrast, when execution in the bare metal environment is not needed, the operation of FIG. 9 ends.

In Step S1302, the bare metal building unit 1243 determines whether or not the corresponding processing block is to be subjected to parallel execution (multi-core parallel execution). The determination is performed by detecting whether or not a directive of a parallel library (for example, OpenMP (trademark)) is inserted at a portion corresponding to the corresponding processing block in the computation application body code 1320. When the corresponding processing block is subjected to parallel execution, the number of cores required by the corresponding processing block can be identified by referring to environment variables of the parallel library.

When the bare metal building unit 1243 determines that execution of the corresponding processing block in the bare metal environment is needed in Step S1301, in Step S1303, the bare metal building unit 1243 checks whether or not the bare metal environment has already been built for a necessary number of cores. When the bare metal environment has been built for the necessary number of cores, the operation proceeds to Step S1304. In contrast, when the bare metal environment has not been built for the necessary number of cores, the operation proceeds to Step S1306.

In Step S1304, the bare metal building unit 1243 checks whether or not the bare metal environment has already been built for more than the necessary number of cores. When the bare metal environment has already been built for more than the necessary number of cores, the operation of FIG. 9 ends. In contrast, when the bare metal environment has not yet been built for more than the necessary number of cores, the operation proceeds to Step S1305.

In Step S1305, for example, the bare metal building unit 1243 logically turns on an unnecessary number of cores with use of a Hotplug function of the operating system 1200, and thereby restores them to the cores controlled by the operating system 1200.

When the bare metal building unit 1243 determines that the bare metal environment has not been built for the necessary number of cores in Step S1303, in Step S1306, the bare metal building unit 1243 acquires overhead times of a series of operations related to building of the bare metal environment from the bare metal building latency table 1244 to be described later.

In Step S1307, the bare metal building unit 1243 determines whether or not a total value of the overhead times acquired in Step S1306 is before start time of the next period of the corresponding processing block. When it is before the start time of the next period of the corresponding processing block, the operation proceeds to Step S1308. In contrast, when it is not before the start time of the next period of the corresponding processing block, the operation proceeds to Step S1309.

In Step S1308, the bare metal building unit 1243 logically turns off the necessary number of cores with use of the Hotplug function of the operating system 1200.

In Step S1309, the bare metal building unit 1243 executes the next period in the OS environment, and then logically turns off the necessary number of cores in the further next period. Note that the cores for which the bare metal environment is built are any one(s) of the processor cores 1100-1 to 1100-4 included in the computation apparatus 1001, and are cores that are not logically turned off by the operating system 1200.

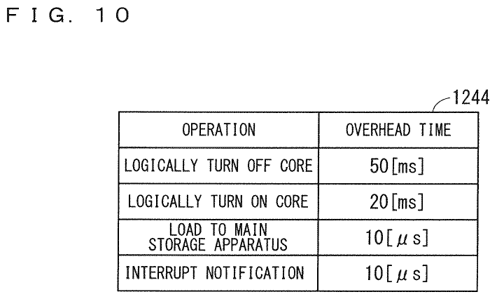

FIG. 10 is a diagram illustrating an example of the bare metal building latency table 1244.

The bare metal building latency table 1244 stores an overhead time (time required) for each operation related to building of the bare metal environment. The overhead time of an operation is measured at the preparation stage, and is reflected in the bare metal building latency table 1244. Note that the overhead times of respective operations illustrated in FIG. 10 are reference values.

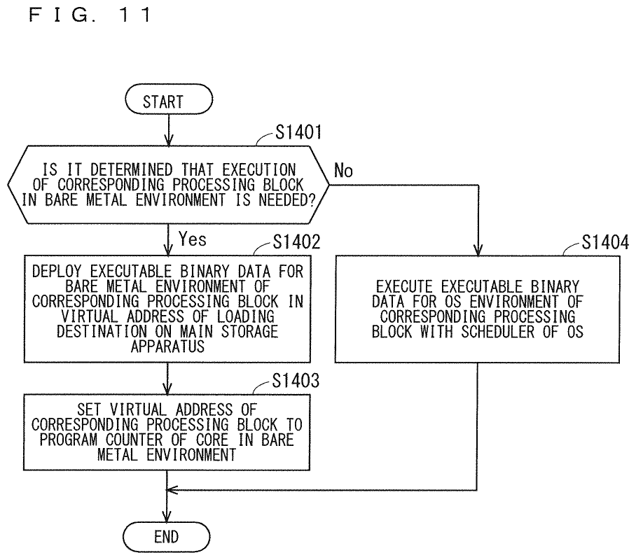

FIG. 11 is a flowchart illustrating an example of operation of the bare metal loader unit 1245.

In Step S1401, the bare metal loader unit 1245 checks whether or not it is determined that execution of the corresponding processing block in the bare metal environment is needed. When execution of the corresponding processing block in the bare metal environment is needed, the operation proceeds to Step S1402. In contrast, when execution of the corresponding processing block in the bare metal environment is not needed, the operation proceeds to Step S1404.

In Step S1402, the bare metal loader unit 1245 deploys the executable binary data for the bare metal environment of the corresponding processing block in a virtual address of a loading destination on a main storage apparatus (not illustrated) included in the computation apparatus 1001. Note that there is a presupposition that the virtual address of the loading destination is designated by the user in advance.

In Step S1403, the bare metal loader unit 1245 sets the virtual address (entry point) of the corresponding processing block to a program counter of the core in the bare metal environment, and sets it in a RUNNING state.

Note that register information including the program counter of each core can be acquired from a device tree in a case of Linux, for example. Further, the corresponding processing block set in the RUNNING state uses a polling function of the function table 1330 to be described later and thereby polls an interrupt request for giving notification of starting, and executes processing when detecting the interrupt request.

In Step S1404, the bare metal loader unit 1245 executes the executable binary data for the OS environment of the corresponding processing block with a scheduler included in the operating system 1200.

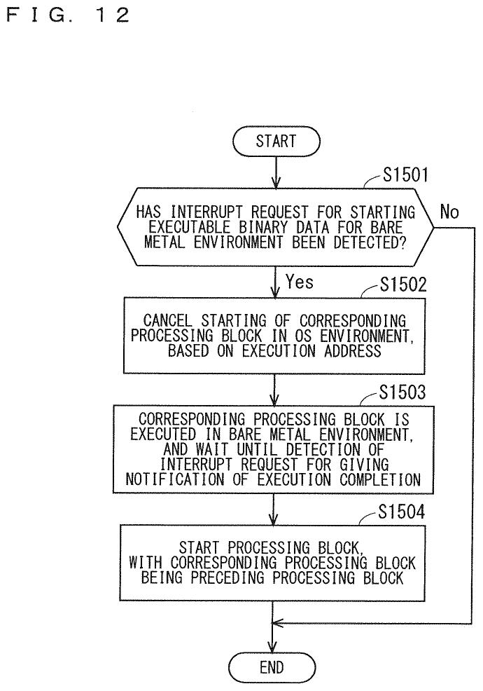

FIG. 12 is a flowchart illustrating an example of operation of the bare metal cooperation unit 1246.

In Step S1501, the bare metal cooperation unit 1246 determines whether or not an interrupt request for starting the executable binary data for the bare metal environment has been detected. When the interrupt request for starting the executable binary data for the bare metal environment has been detected, the operation proceeds to Step S1502. In contrast, when the interrupt request for starting the executable binary data for the bare metal environment has not been detected, the operation of FIG. 12 ends.

In Step S1502, the bare metal cooperation unit 1246 cancels starting of the corresponding processing block in the OS environment, based on an execution address.

In Step S1503, the corresponding processing block is executed in the bare metal environment, and the bare metal cooperation unit 1246 waits until detection of an interrupt request for giving notification of execution completion.

When the bare metal cooperation unit 1246 has detected the interrupt request in Step S1503, in Step S1504, the bare metal cooperation unit 1246 starts a processing block (that is, a following processing block), with the corresponding processing block being a preceding processing block.

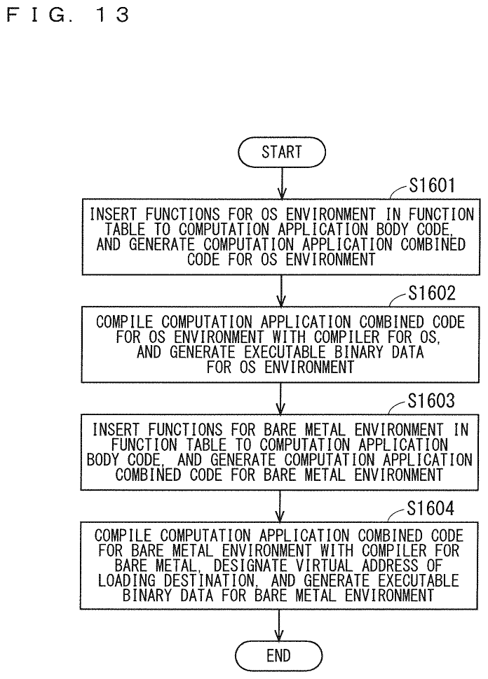

FIG. 13 is a flowchart illustrating an example of operation of the computation application generation unit 1310.

In Step S1601, the computation application generation unit 1310 inserts functions for the OS environment in the function table 1330 to be described later to the computation application body code 1320, and generates the computation application combined code 1340 for the OS environment.

In Step S1602, the computation application generation unit 1310 compiles the computation application combined code 1340 for the OS environment with a compiler for the OS (for example, GNU Compiler Collection (GCC (trademark)), and generates the executable binary data for the OS environment.

In Step S1603, the computation application generation unit 1310 inserts functions for the bare metal environment in the function table 1330 to the computation application body code 1320, and generates the computation application combined code 1340 for the bare metal environment.

In Step S1604, the computation application generation unit 1310 compiles the computation application combined code 1340 for the bare metal environment with a compiler for the bare metal, designates a virtual address of a loading destination, and generates the executable binary data for the bare metal environment. The virtual address of the loading destination is determined by the user in advance, and after the executable binary data for the bare metal environment is loaded, with use of a memory locking function of the function table 1330, a space of any size starting from the virtual address of the loading destination is secured as a space not to be swapped out. This produces an effect of preventing jitter in an application operating in the bare metal environment due to swap-out when the application is executed.

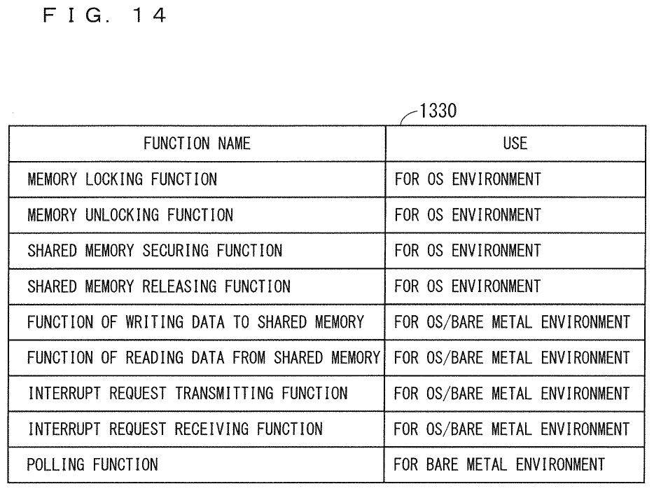

FIG. 14 is a diagram illustrating an example of the function table 1330.

Inserting the functions illustrated in the function table 1330 to the computation application body code 1320 enables cooperative operation of the executable binary data for the OS environment and the executable binary data for the bare metal environment.

It is assumed that the executable binary data for the bare metal environment is deployed in a space, on a virtual address space, of a size determined by the user in advance. Usually, when a physical address space of the main storage apparatus is exhausted, swap-out may occur due to memory management of the OS and jitter may thereby be caused. Thus, in a space used for the executable binary data for the bare metal environment, memory is locked so as not to allow swap-out. Functions to implement this are a memory locking function and a memory unlocking function in the function table 1330, and two system calls, namely mlock ( ) and munlock ( ), are used when Linux is used, for example.

In order to perform data communication between processing blocks that are included in the binary data for the OS environment and the executable binary data for the bare metal environment and have dependence on each other, a shared memory space is set to enable reading and writing from both of the executable binary data. Functions to implement this are a shared memory securing function, a shared memory releasing function, a function of writing data to the shared memory, and a function of reading data from the shared memory in the function table 1330.

For execution control of the processing blocks that are included in the binary data for the OS environment and the executable binary data for the bare metal environment and have dependence on each other, interrupts between the cores are used. An interrupt request (starting notification) for giving notification of starting of the corresponding processing block is transmitted from an OS environment core (a core in which the OS environment is built) to a bare metal environment core (a core in which the bare metal environment is built), and is received in the bare metal environment core. In the bare metal environment core, the corresponding processing block polls the interrupt request, and executes processing when detecting the interrupt request. After the processing of the corresponding processing block has completed, the bare metal environment core transmits an interrupt request (completion notification) for giving notification of completion from the bare metal environment core to the OS environment core, and the OS environment core receives the interrupt request. Functions to implement this are an interrupt request transmitting function, an interrupt request receiving function, and a polling function in the function table 1330.

### Effects of First Embodiment

In the first embodiment, change of the processing time of the processing block over time and change of the statistical information of OS jitter over time are monitored, and the processing block is dynamically executed in the bare metal environment, based on the bare metal necessity determination table 1241 defined by the user. With this, OS jitter can be reduced, depending on a state of execution of an application.

### Second Embodiment

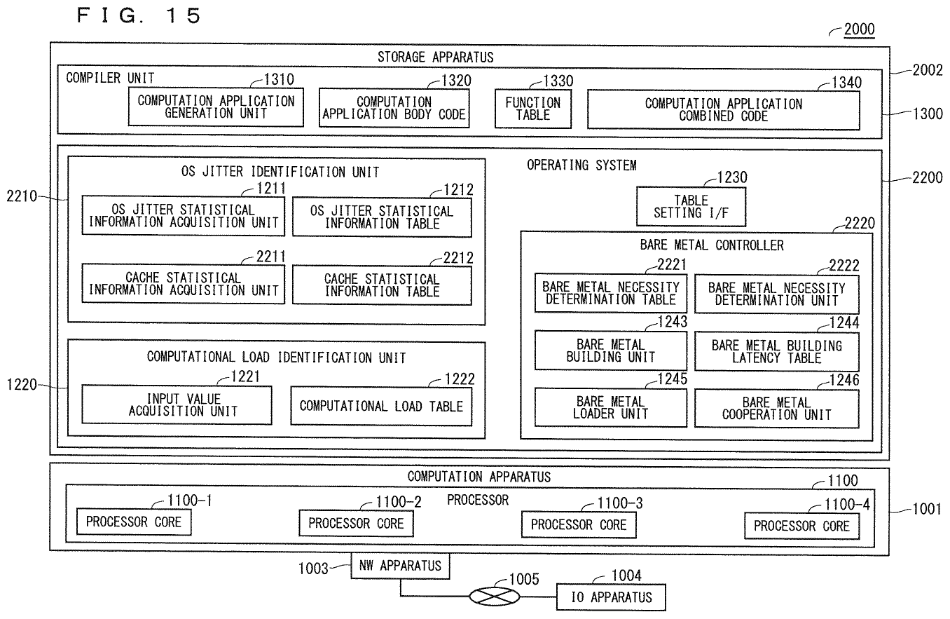

FIG. 15 is a block diagram illustrating an example of a configuration of an information processing apparatus 2000 according to a second embodiment.

The information processing apparatus 2000 includes the computation apparatus 1001 and a storage apparatus 2002, and the storage apparatus 2002 includes an operating system 2200. Specifically, an OS jitter identification unit 2210 includes a cache statistical information acquisition unit 2211 and a cache statistical information table 2212, and a bare metal controller 2220 includes a bare metal necessity determination table 2221 and a bare metal necessity determination unit 2222. Other configurations and operations are similar to those of the information processing apparatus 1000 according to the first embodiment, and thus detailed description will be herein omitted.

The cache statistical information acquisition unit 2211 acquires statistical information related to cache memory. Note that the cache memory is included in the computation apparatus 1001.

Regarding the cache statistical information table 2212, for each of items to be monitored in the cache memory, ranges of numerical values thereof and their corresponding levels (cache performance levels) are set by the user.

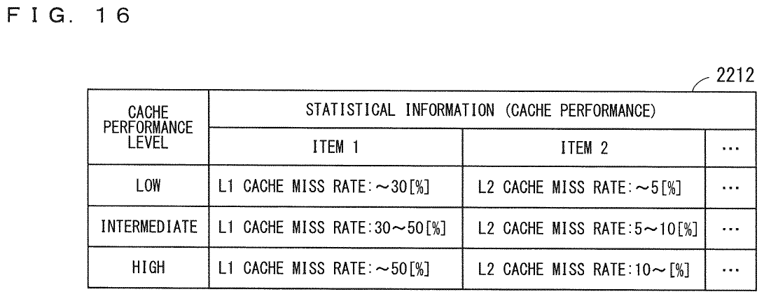

FIG. 16 is a diagram illustrating an example of the cache statistical information table 2212.

One main cause of variation of the processing times of a processing block is whether or not a cache memory hit occurs. It is assumed that the computation apparatus 1001 in the information processing apparatus 2000 includes cache memory. A larger number of applications executed in the information processing apparatus 2000 leads to a higher cache miss rate, and no occurrence of a cache hit makes a difference in the processing times, even when the computational load is the same. Thus, recognition of cache statistical information is crucial to recognition of a state of execution of an application.

The cache statistical information table 2212 illustrated in FIG. 16 has the same format as that of the OS jitter statistical information table 1212 illustrated in FIG. 3. At the preparation stage, the user sets monitoring items related to cache, ranges of numerical values thereof, and their cache performance levels. Note that, in the example of FIG. 16, the monitoring items are an L1 cache miss rate and an L2 cache miss rate, but are not limited to these. Further, the cache performance levels are three levels of “low”, “intermediate”, and “high”, but are not limited to this.

The cache statistical information may be acquired using a performance monitoring unit (PMU) provided by a CPU vendor, or may be acquired using a performance analysis tool (for example, perf in Linux) provided by the general-purpose OS. The processing is performed by the cache statistical information acquisition unit 2211.

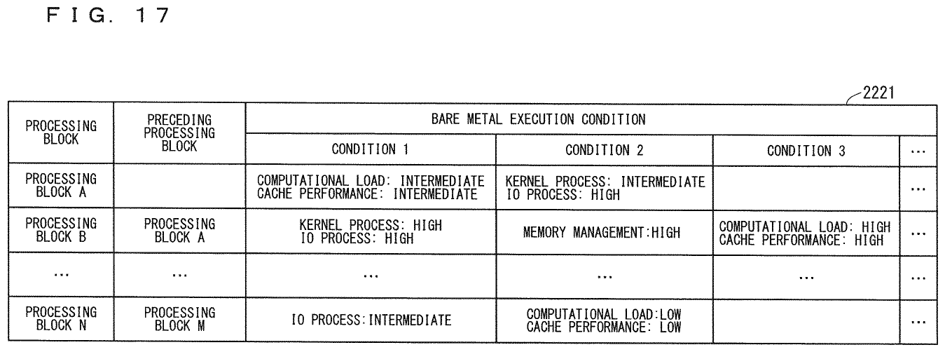

FIG. 17 is a diagram illustrating an example of the bare metal necessity determination table 2221.

The bare metal necessity determination table 2221 illustrated in FIG. 17 has the same format as that of the bare metal necessity determination table 1241 illustrated in FIG. 7. In addition to the types of OS jitter set in the OS jitter statistical information table 1212 and the computational load set in the computational load table 1222, the cache performance set in the cache statistical information table 2212 is set to the bare metal execution condition.

In the example of FIG. 17, regarding the processing block A, respective levels of the computational load and the cache performance are set to “condition 1” as AND conditions, respective levels of the kernel process and the IO process are set to “condition 2” as AND conditions, and “condition 1” and “condition 2” are OR conditions. Note that the cache performance may also be set only when the cache performance is necessary for determination that execution of the corresponding processing block in the bare metal environment is needed.

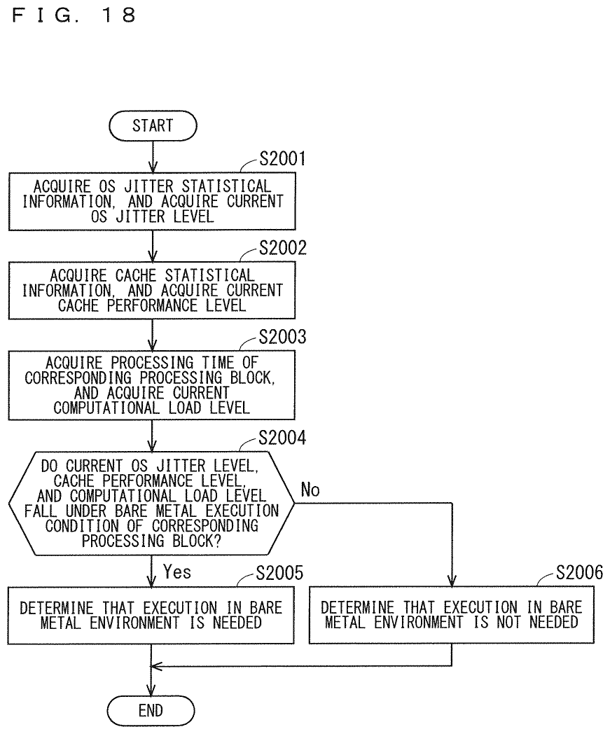

FIG. 18 is a flowchart illustrating an example of operation of the bare metal necessity determination unit 2222. Step S2001, Step S2003, Step S2005, and Step S2006 of FIG. 18 are similar to Step S1201 to Step S1205 of FIG. 8, and thus description will be herein omitted. Step S2002 and Step S2004 will be described below. Note that it is assumed that processing of bare metal necessity determination is performed when the preceding processing block of the corresponding processing block is executed.

In Step S2002, the bare metal necessity determination unit 2222 acquires the current cache statistical information from the cache statistical information acquisition unit 2211, makes an inquiry to the cache statistical information table 2212, and acquires a corresponding cache performance level.

In Step S2004, the bare metal necessity determination unit 2222 makes an inquiry about the current OS jitter level, cache performance level, and computational load level to the bare metal necessity determination table 2221, and checks whether or not the current OS jitter level, cache performance level, and computational load level fall under the bare metal execution condition of the corresponding processing block.

### Effects of Second Embodiment

In the second embodiment, statistical information related to cache memory (cache statistical information) that affects the processing time of the processing block is acquired, and whether or not execution in the bare metal environment based on the cache statistical information is needed is determined. With this, OS jitter can be reduced mom finely, depending on a state of execution of an application.

### Third Embodiment

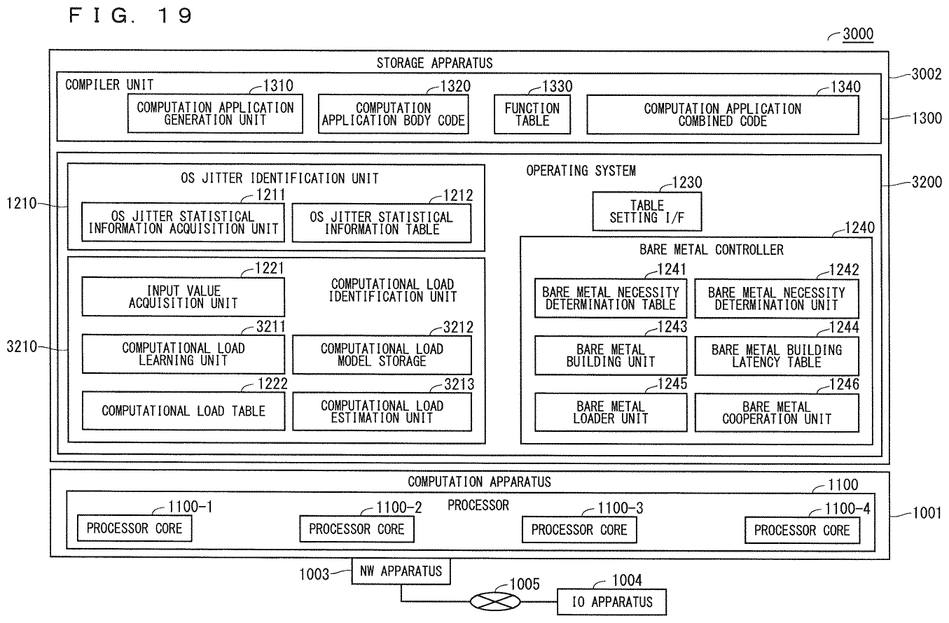

FIG. 19 is a block diagram illustrating an example of a configuration of an information processing apparatus 3000.

The information processing apparatus 3000 includes the computation apparatus 1001 and a storage apparatus 3002, and the storage apparatus 3002 includes an operating system 3200. Specifically, a computational load identification unit 3210 includes a computational load learning unit 3211, a computational load model storage 3212, and a computational load estimation unit 3213. Other configurations and operations are similar to those of the information processing apparatus 1000 according to the first embodiment, and thus detailed description will be herein omitted.

The computational load learning unit 3211 measures processing times of processing blocks, and learns tendency of the processing times with respect to acquired input values. A model learned by the computational load learning unit 3211 is stored in the computational load model storage 3212. The computational load estimation unit 3213 estimates the processing times from newly acquired input values and the learned model, and identifies the computational load level with reference to the computational load table 1222.

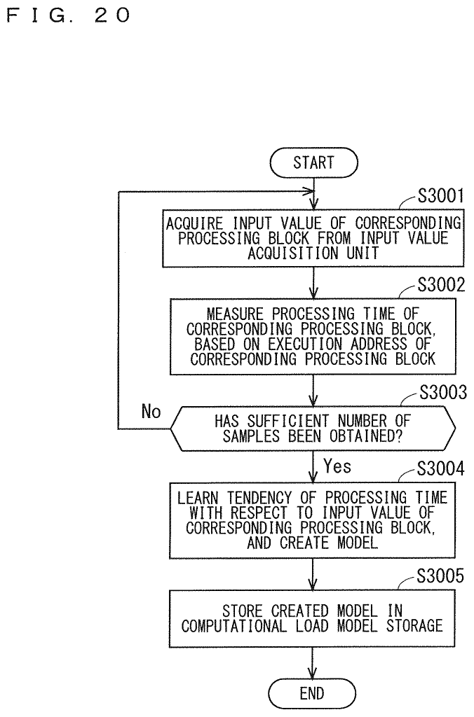

FIG. 20 is a flowchart illustrating an example of operation of the computational load learning unit 3211.

In Step S3001, the computational load learning unit 3211 acquires input values of the corresponding processing block from the input value acquisition unit 1221.

In Step S3002, the computational load learning unit 3211 measures the processing time of the corresponding processing block, based on an execution address of the corresponding processing block.

In Step S3003, the computational load learning unit 3211 determines whether or not a sufficient number of samples has been obtained. Here, the sufficient number of samples may be defined by the user in advance, for example. When the sufficient number of samples has been obtained, the operation proceeds to Step S3004. In contrast, when the sufficient number of samples has not been obtained, the operation returns to Step S3001.

In Step S3004, the computational load learning unit 3211 learns tendency of the processing times with respect to the input values of the corresponding processing block, and creates a model.

In Step S3005, the computational load learning unit 3211 stores the created model in the computational load model storage 3212. In learning of the model, for example, learning is performed such that the measured processing time is estimated from sequential data of input values acquired in a plurality of consecutive periods with use of a recurrent neural network (RNN). Note that an algorithm used in the learning is not limited to the RNN. Further, the learning of the processing times with respect to the input values may be performed at the operation stage. For example, when functions of a computation application are updated, the computational load may change due to a change made to internal processing, even when the input value is the same.

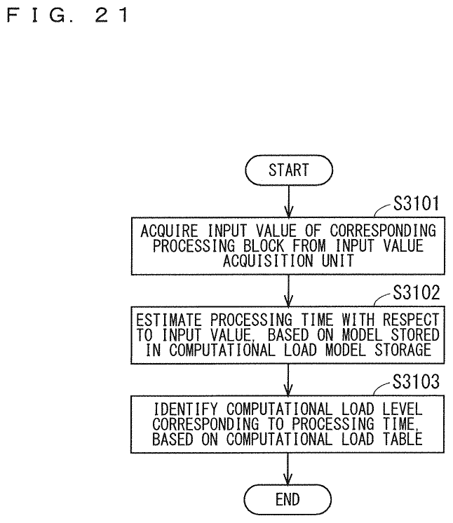

FIG. 21 is a flowchart illustrating an example of operation of the computational load estimation unit 3213.

In Step S3101, the computational load estimation unit 3213 acquires an input value of the corresponding processing block from the input value acquisition unit 1221.

In Step S3102, the computational load estimation unit 3213 estimates the processing time with respect to the acquired input value, based on the model stored in the computational load model storage 3212.

In Step S3103, the computational load estimation unit 3213 makes an inquiry about the estimated processing time to the computational load table 1222, and identifies a corresponding computational load level.

### Effects of Third Embodiment

In the third embodiment, the computational load with respect to the input value of the processing block is learned and inferred. With this, the computational load can be easily identified even when a change is made to functions of a computation application or the like at the operation stage.

Note that, in the scope of the present disclosure, each of the embodiments can be freely combined, and each of the embodiments can be modified or omitted as appropriate.

While the present disclosure has been described in detail, the foregoing description is in all aspects illustrative and not restrictive. It is therefore understood that numerous unillustrated modifications can be devised.

### EXPLANATION OF REFERENCE SIGNS

1000 Information processing apparatus, 1001 Computation apparatus, 1002 Storage apparatus, 1003 NW apparatus, 1004 IO apparatus, 1005 Network, 1100 Processor, 1100-1 to 1100-4 Processor core, 1200 Operating system, 1210 OS jitter identification unit, 1211 OS jitter statistical information acquisition unit, 1212 OS jitter statistical information table, 1212-1 Kernel process, 1212-2 IO process, 1212-3 Memory management, 1220 Computational load identification unit, 1221 Input value acquisition unit, 1222 Computational load table, 1222-1 to 1222-3 Table, 1230 Table setting I/F, 1240 Bare metal controller, 1241 Bare metal necessity determination table, 1242 Bare metal necessity determination unit, 1243 Bare metal building unit, 1244 Bare metal building latency table, 1245 Bare metal loader unit, 1246 Bare metal cooperation unit, 1300 Compiler unit, 1310 Computation application generation unit, 1320 Computation application body code, 1330 Function table, 1340 Computation application combined code, 2000 Information processing apparatus, 2002 Storage apparatus, 2200 Operating system, 2210 OS jitter identification unit, 2211 Cache statistical information acquisition unit, 2212 Cache statistical information table, 2220 Bare metal controller, 2221 Bare metal necessity determination table, 2222 Bare metal necessity determination unit, 3000 Information processing apparatus, 3002 Storage apparatus, 3200 Operating system, 3210 Computational load identification unit, 3211 Computational load learning unit, 3212 Computational load model storage, 3213 Computational load estimation unit

1. An information processing apparatus that executes an application, the information processing apparatus comprising:
a computation apparatus including a plurality of processor cores; and
an operating system to be executed in the computation apparatus, wherein
the operating system includes
an OS jitter statistical information acquisition unit configured to acquire OS jitter statistical information being statistical information of OS jitter occurring in processing of the operating system,
an OS jitter statistical information table defining an OS jitter level being a level of OS jitter, the OS jitter level being associated with the OS jitter statistical information,
an input value acquisition unit configured to acquire an input value of the application,
a computational load table defining a computational load level being a level of a computational load of a processing block constituting the application, the computational load level being associated with the input value, and
a bare metal necessity determination unit configured to determine whether or not the processing block needs to be executed in a bare metal environment in which the operating system is not executed, based on the OS jitter level and the computational load level.

2. The information processing apparatus according to claim 1, wherein
the operating system further includes
a table setting I/F,
a bare metal necessity determination table defining a bare metal execution condition being a condition necessary for executing the processing block in the bare metal environment using the OS jitter level and the computational load level, and
a bare metal building unit configured to build the bare metal environment for one of the plurality of processor cores for which the bare metal environment is not built,
the bare metal execution condition is set by a user via the table setting I/F, and
when the OS jitter level and the computational load level meet the bare metal execution condition, the bare metal necessity determination unit determines that the processing block needs to be executed in the bare metal environment.

3. The information processing apparatus according to claim 1, wherein
the operating system further includes
a bare metal building unit configured to build the bare metal environment for one of the plurality of processor cores for which the bare metal environment is not built, and
a bare metal building latency table storing an overhead time required for building of the bare metal environment, and
when the overhead time is before start time of the processing block, the bare metal building unit builds the bare metal environment, based on the overhead time.

4. The information processing apparatus according to claim 1, further comprising
a computation application generation unit configured to generate executable binary data for an operating system environment that is executable in the operating system environment in which the operating system is executed and executable binary data for the bare metal environment that is executable in the bare metal environment, based on a computation application body code being a body code of the application and a function table, wherein
a starting notification or a completion notification is transmitted and received between the processing blocks being included in the executable binary data for the operating system environment and the executable binary data for the bare metal environment and having dependence on each other.

5. The information processing apparatus according to claim 4, further comprising:
a main storage apparatus;
a bare metal loader unit configured to deploy the executable binary data for the bare metal environment in a predetermined virtual address of the main storage apparatus, and set an entry point of the processing block as an execution target included in the executable binary data for the bare metal environment to a program counter of one of the plurality of processor cores in the bare metal environment; and
a bare metal cooperation unit configured to perform control so that the processing block is not to be executed in the operating system based on the starting notification transmitted from the executable binary data for the operating system environment to the executable binary data for the bare metal environment, and perform control so that a processing block to be executed after the processing block is to be executed in the operating system, based on the completion notification transmitted from the executable binary data for the bare metal environment to the executable binary data for the operating system environment.

6. The information processing apparatus according to claim 2, wherein
the computation apparatus further includes cache memory,
the operating system further includes
a cache statistical information acquisition unit configured to acquire cache statistical information being statistical information related to the cache memory, and
a cache statistical information table defining a cache performance level being a level of cache performance, the cache performance level being associated with the cache statistical information,
in the bare metal necessity determination table, the bare metal execution condition is defined using the OS jitter level, the computational load level, and the cache performance, and
when the OS jitter level, the computational load level, and the cache performance level meet the bare metal execution condition, the bare metal necessity determination unit determines that the processing block needs to be executed in the bare metal environment.

7. The information processing apparatus according to claim 1, wherein
the operating system further includes
a computational load learning unit configured to learn the computational load of the processing block with respect to the input value acquired by the input value acquisition unit and generate a computational load model, and
a computational load estimation unit configured to estimate the computational load of the processing block, based on the input value acquired by the input value acquisition unit and the computational load model.
